(19) United States
(12) Patent Application Publication
(10) Pub. No.: US 2008/0109981 A1
(43) Pub. Date: May 15, 2008

(54) Rearview mirror wiping device

(76) Inventor: Stephen Sell Buckingham, Springfield, VT (US)

Correspondence Address: STEPHEN S. BUCKINGHAM, 4 PINEWOOD AVE., SPRINGFIELD, VT, 05156, US

(21) Appl. No.: 11/599,823

(22) Filed: Nov. 15, 2006

(51) Int. Cl. B60S 1/08; B60S 1/20

(52) U.S. Cl. 15/250.03

(57) ABSTRACT

A remotely operated mirror wiping device comprising a frame, mirror, two guide rails, a wiper arm guided on each end by said guide rails with a spring loaded squeegee blade, a crossed loop cable with a tensioning spring, guide pulleys oriented to drive said wiper arm by means of said guide rails across said mirror by said cable, and an oscillating driving device consisting of either an oscillating motor with a drive pulley or a linear motor or cylinder with automatic reversal at each end.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION—FIELD OF INVENTION

This invention is a mirror wiping device for highway vehicles.

### BACKGROUND OF THE INVENTION—PRIOR ART

One problem with driving highway vehicles—in particular trucks and buses—is the difficulty of keeping rearview mirrors clean in inclement weather. Automobiles generally have interior rearview mirrors and most now have means to keep the rear windshield clean, so they are not as critically affected as trucks and buses, which rely almost entirely on exterior mounted mirrors for rear vision. Under normal conditions they function adequately, but during rain or snow they can quickly become so covered with moisture and/or road debris as to be useless. Heated mirrors are widely available but they do not provide adequate protection in many weather conditions. The origin of the present invention came when the inventor had to drive a truck on a long trip on a day when the weather was such that after less than a mile of travel the mirrors became completely obscured and thus were useless.

This is not a new problem, obviously, and many attempts have been made to solve it. The inventor has found at least 33 prior patents on wiping devices for vehicle mirrors, and yet not one has found commercial success. In order to be successful, a wiping device must meet certain criteria. First, it must be simple, rugged, and reliable. Second, it must be as unobtrusive to the driver as possible. Third, it must be able to survive and function in all types of weather; including freezing rain, which will liberally coat everything it hits with a layer of ice. Fourth, it must be as economical as possible to manufacture and install, as trucking is an extremely competitive business and most truck buyers will not be willing to pay large sums for items that are not absolutely essential. Finally, it must be packaged in an attractive and unobtrusive manner so as to not be aesthetically displeasing.

Several patents have been granted for devices that have significant space on one or both sides of the mirror occupied by mechanism; these would be objectionable because they present a significant blockage to the driver's vision; the mirror itself is blockage enough, and most drivers would regard anything that extends beyond the sides of the mirror to be unacceptable. Examples of this are U.S. Pat. No. 6,453,504 to Burkard et al, Sep. 24, 2002, U.S. Pat. No. 6,654,982 to Cowan, Dec. 2, 2003, and U.S. Pat. No. 6,772,469 to Pidgeon, Aug. 10, 2004.

The simplest way of accomplishing the task would be to have a conventional wiper arm with a parallelogram linkage and a conventional wiper motor behind the mirror; variations of this have been patented several times, notably U.S. Pat. No. 3,855,661 to Prince, Dec. 24, 1974, U.S. Pat. No. 4,763,381 to Williams, Aug. 16, 1988, and U.S. Pat. No. 5,760,956 to Maccan, Jun. 2, 1998. A related attempt was to make the shape of the mirror conform to the wiper path as in patent 2,944,277 to Ochello, Jul. 12, 1960. In the opinion of the inventor these failed primarily because they were too intrusive on the driver's vision as the wiper arm would always be over an important part of the mirror, or, in the case of 2,944,277 to Ochello et al, Jul. 12, 1960, it was aesthetically unacceptable as well as having the motor partially obscuring the driver's vision.

There are several patents for wipers that are horizontal across the surface of the mirror and travel vertically up and down; examples are U.S. Pat. No. 4,457,597 to DeGideo, Jul. 3, 1984, U.S. Pat. No. 4,873,740 to Vahrenwald et al, Oct. 17, 1989, and U.S. Pat. No. 6,546,590 to Waters, Apr. 15, 2003. This inventor considers that approach to be unacceptable because it would tend to collect rain, snow, and dirt on top of the wiper blade and would therefore be much less likely to clean the mirror in a single pass.

By elimination this leaves a vertical blade traveling across the face of the mirror guided on the top and/or bottom as the only acceptable option. There are also quite a number of patents using this approach, such as U.S. Pat. No. 6,691,365 to Graf, Feb. 17, 2004 which utilizes a oscillating drum and two cables driving a wiper blade on tracks. The biggest problem with this design is that the cables are driven strictly by friction on the drum, and if they slip the blade will become misaligned and almost certainly jammed. Another approach is demonstrated by U.S. Pat. No. 5,353,466 to Smith et al, Oct. 11, 1994. This approach relies on microswitches to reverse the blade, which this inventor considers undesirable, as it requires more wires and a control module. Also, this leaves the microswitches potentially exposed to water and salt, reducing the reliability and increasing the cost if the microswitches are sufficiently weatherproof. Another problem is the fact that wire rope is subject to much more fatigue when going over extremely small pulleys, and this design relies on very small pulleys to achieve the desired package. This objection also applies to U.S. Pat. No. 5,363,236 to Han, Nov. 8, 1994. A different approach is demonstrated by U.S. Pat. No. 4,339,169 to Addison, Jr., Jul. 13, 1982. This relies on a wiper on a bracket looping around the mirror and driven by a bellcrank, and guided by recirculating ball bushings riding on rods. This would be very difficult to keep clean enough to continue working in the environment of a heavy duty highway vehicle. The same applies to U.S. Pat. No. 3,526,920 to Boyanich, Sep. 8, 1970. There are several other approaches that have been tried, but as mentioned earlier, none has found commercial acceptance.

### BACKGROUND OF THE INVENTION—OBJECTS AND ADVANTAGES

Accordingly, the present invention incorporates the following advantages:

a) It is operated by an existing gearmotor already in mass production and of a proven, reliable design, providing the necessary oscillatory motion as well as a built-in parking function requiring only two wires for power if the chassis is used for return; or three wires if a separate ground is desired.
b) It is driven by a single stainless steel wire rope over pulleys large enough to minimize fatigue and secured to both the wiper and the driving pulley to eliminate the possibility of slippage.
c) The wiper is guided on the upper end by a guide with an anti-friction liner riding on an inverted L-shaped track provided with a protective cover so as to minimize its susceptibility to ice and snow blocking its travel. It is similarly guided on the lower end by a guide and vertical blade track located under the housing for protection.
d) The main housing can be symmetrical, allowing the same components to be used to provide either left-side or right-side parking by inverting the main housing and related components. Alternatively, the housing can be asymmetrical and the cable can be wound around the drive sheave in the opposite direction to park on the opposite side which still would use the same components for left hand and right hand versions.

### The end result is a mirror wiping device that is very simple to build and operate, is housed in an attractive, unobtrusive, and streamlined protective housing, and is almost completely immune to stoppage by ice, snow, and other debris.

### SUMMARY

In accordance with the present invention a mirror and wiping device for a highway vehicle comprising a frame, an oscillating motor, a driving pulley, eight guide pulleys, a drive cable, a spring to maintain cable tension, a mirror, a mirror inserts, a wiper arm with a replaceable squeegee blade, and a protective and decorative cover.

### DRAWINGS-FIGURES

FIG. 1 shows the complete assembly in an embodiment for heavy duty trucks and buses viewed from the right rear and slightly below with the wiper blade in the parked position.

FIG. 2 shows the same assembly from the right front and slightly below with the near half of the protective housing removed.

FIG. 3 shows the same assembly from the right front slightly below with the mirror and the protective housing removed.

FIG. 4 shows the same assembly from the right side slightly to the rear and slightly below with only the moving components and the mirror retainer to illustrate the guides and bearings.

FIG. 5 shows the same assembly with only the moving components shown viewed from the right rear and above to illustrate the cable path. This view has arrows showing the motion of the cable as it moves from the shown parked position.

### DRAWINGS—REFERENCE NUMERALS

Note: where multiple items are used, they are designated with letters; i.e. 5A, 5B, etc.
1 main housing
2 mirror support (for mounting to the vehicle)
3 drive gearmotor
4 drive pulley
5 idler pulley (8 used)
6 drive cable
7 tensioning spring
8 drive pulley cable clamp
9 mirror
10 mirror retainer with guide tracks
11 upper wiper guide
12 upper guide bearing
13 lower wiper guide
14 lower guide bearing
15 guide cable clamp (2 used)
16 wiper arm
17 replaceable squeegee blade
18 screws securing wiper arm
19 protective cover-left
20 protective cover-right

Note also that fasteners are not called out unless they bear directly on the function and utility of the invention.

### DETAILED DISCUSSION—PREFERRED EMBODIMENT

The drawings show the invention in the preferred embodiment for heavy duty trucks and buses.

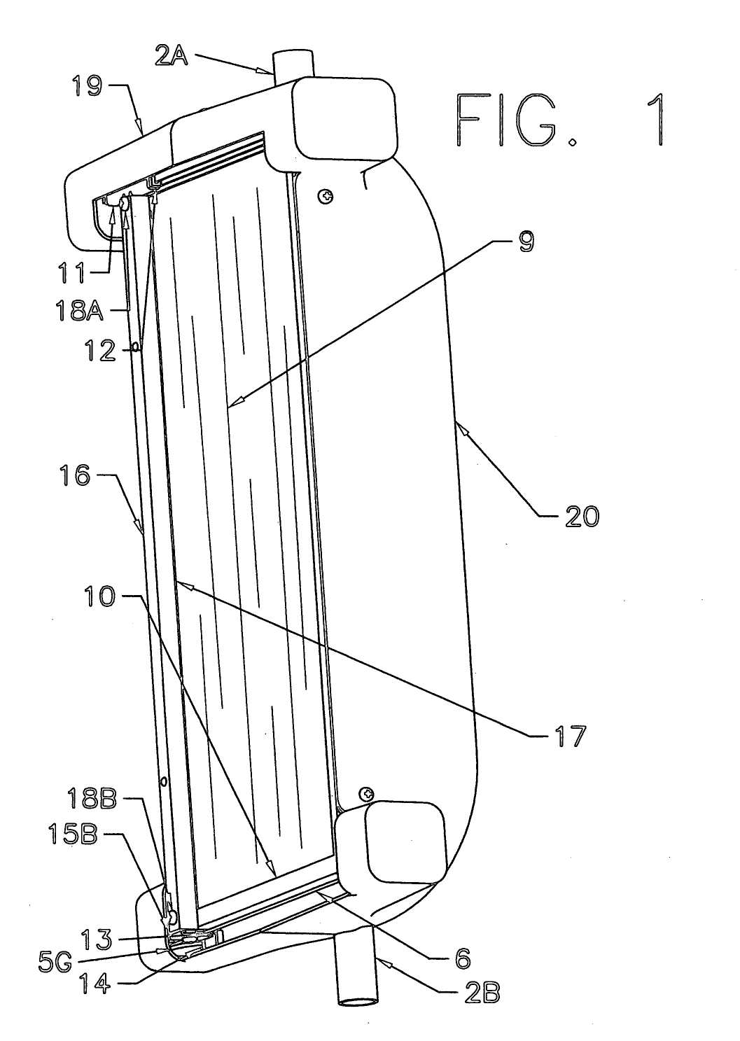

### FIG. 1

FIG. 1 shows the assembly almost as a driver would see it when it would be mounted on the left side of the vehicle, but viewed from slightly below in order to beer show the upper and lower wiper guides 11 and 13. This figure shows that the protective covers 19 & 20 completely enclose the upper guide tracks on all sides except the bottom and the lower guide track on all sides except the rear; this prevents precipitation from falling on the guide tracks or bearings and allows any moisture or debris that is carried onto said guide tracks and bearings by air currents from vehicle motion to be quickly drained off. The squeegee blade 17 is mounted in the wiper arm 16 with bowed spring steel arms (not shown) to provide pressure on the wiping edge, and can be changed by removing the two screws 18A and 18B, allowing the wiper arm to be removed without any other disassembly.

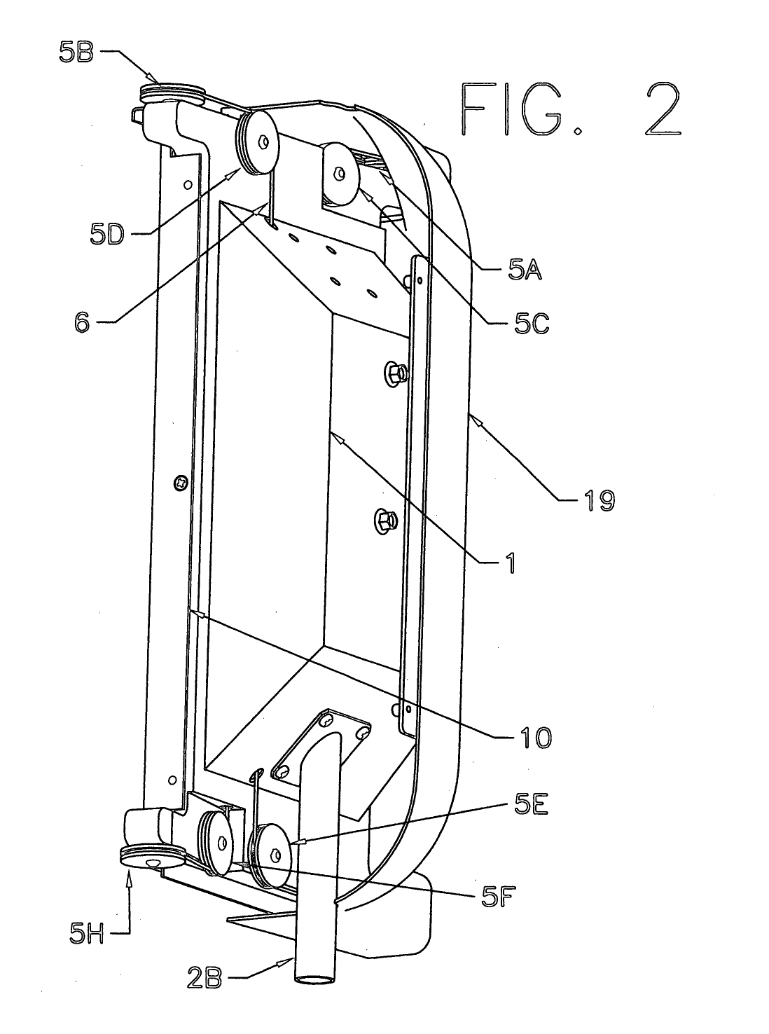

### FIG. 2

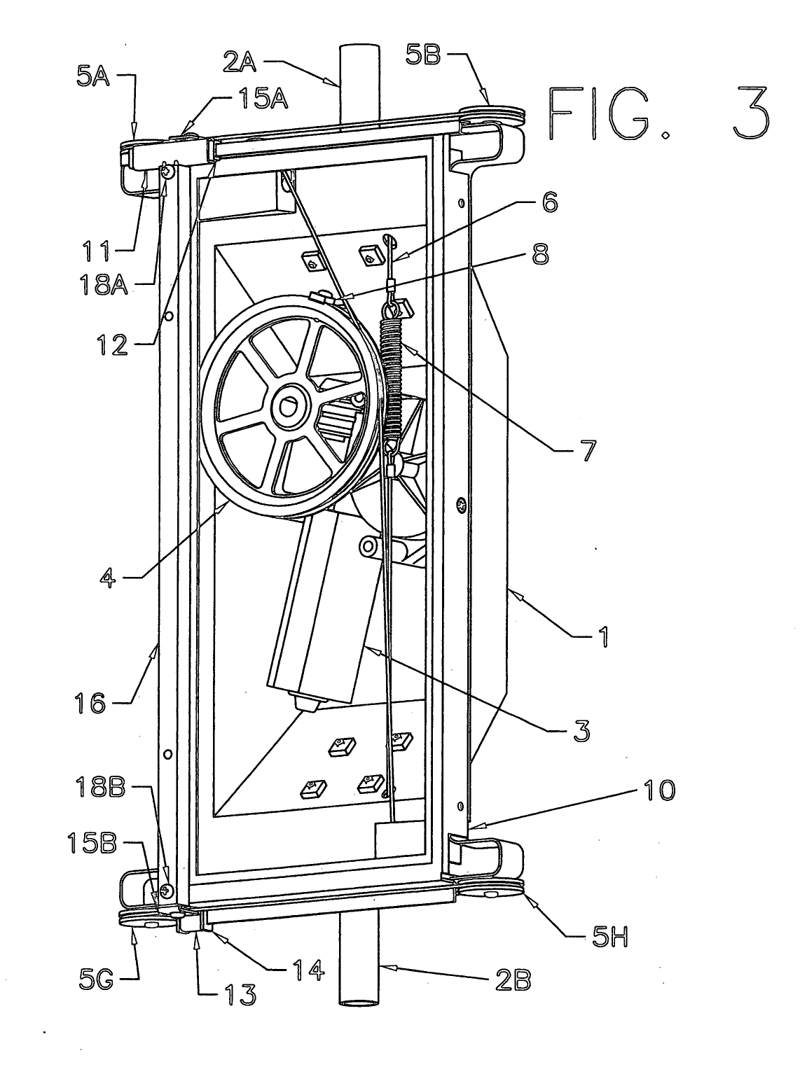

FIG. 2 shows the assembly with the left protective cover 20 and upper mirror support 2A removed. This shows the idler pulleys 5A through 5H mounted on spindles attached to the main housing 1. In particular, it shows that idler pulleys 5C and 5F are mounted on slanted surfaces to allow drive pulley 4 to locate in front drive cable 6 and tensioning spring 7 as shown in FIGS. 3, 4, and 5.

### FIG. 3

FIG. 3 shows the assembly with left and right protective covers 19 and 20 and mirror 9 removed. This view shows the drive gearmotor 3, which is an automotive rear windshield wiper motor which has an output shaft that rotates at an appropriate speed and through a sufficient angle that the drive pulley 4, which has the calculated diameter to move the wiper arm 16 completely across the surface of mirror 9 when said motor travels through its full arc of motion, fits within the main housing 1. Another advantage of using said gearmotor is that it has a built-in parking function which will return wiper arm 16 to the same side of mirror 9 whenever gearmotor 3 is deactivated. Also shown in this figure is the design of housing 1 so that it can be inverted with drive gearmotor 3, pulleys 5A through 5H, drive cable 6, and tensioning spring 7 to cause wiper arm 16 to park on the opposite side. This is desirable to have the blade park on the outside of the mirror on both left and right sides as this would be less obtrusive to the driver than having it on the inside. With this design the same parts can be used to assemble both left and right mirrors; in fact, assembled mirrors can be reversed simply by removing and reversing mirror retainer 10 along with upper wiper guide 11, upper bearing 12, lower wiper guide 13, lower bearing 14, and wiper arm 16.

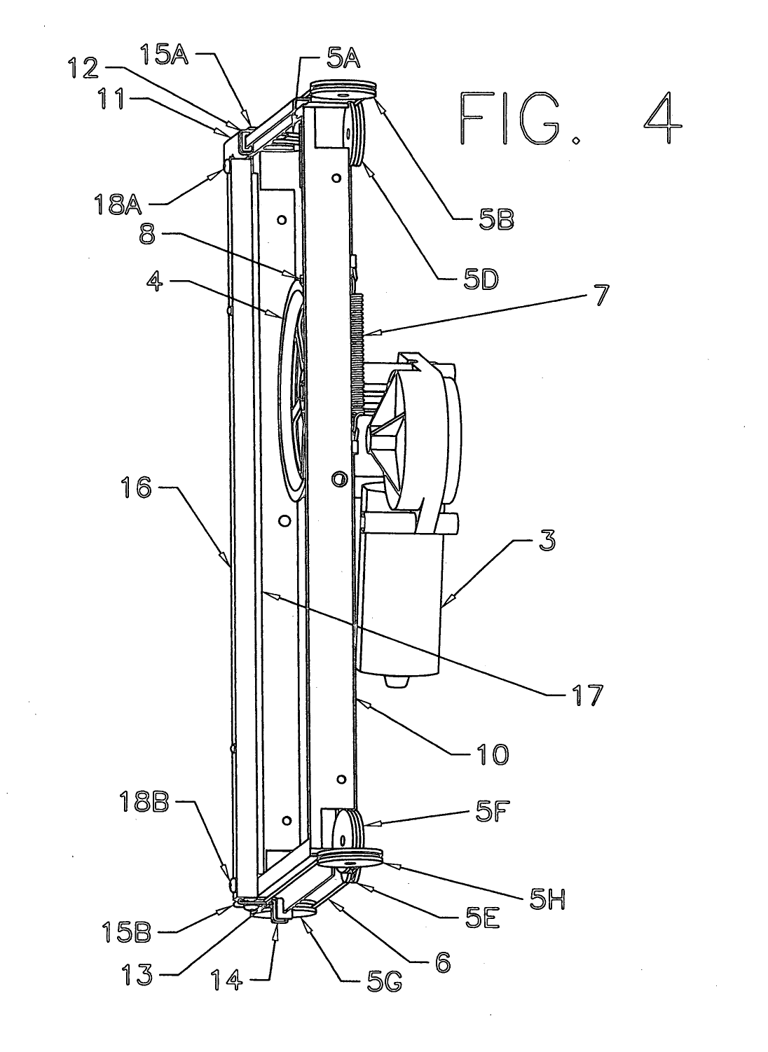

### FIG. 4

FIG. 4 shows all moving components plus the mirror retainer with guide tracks 10. In particular it shows the inverted L-shaped guide track at the top, with upper wiper guide 11 and upper guide bearing 12 shaped so as to provide constraint vertically, horizontally perpendicular to the mirror 9, and rotationally along the axis of wiper arm 16; plus the guide track on the bottom which restrains the wiper arm 16 in the plane perpendicular to mirror 9, allowing only linear movement across the face of mirror 9. It also shows how the shape of the guide tracks minimizes the opportunity for snow, ice, or other debris to collect on the guide tracks and block motion.

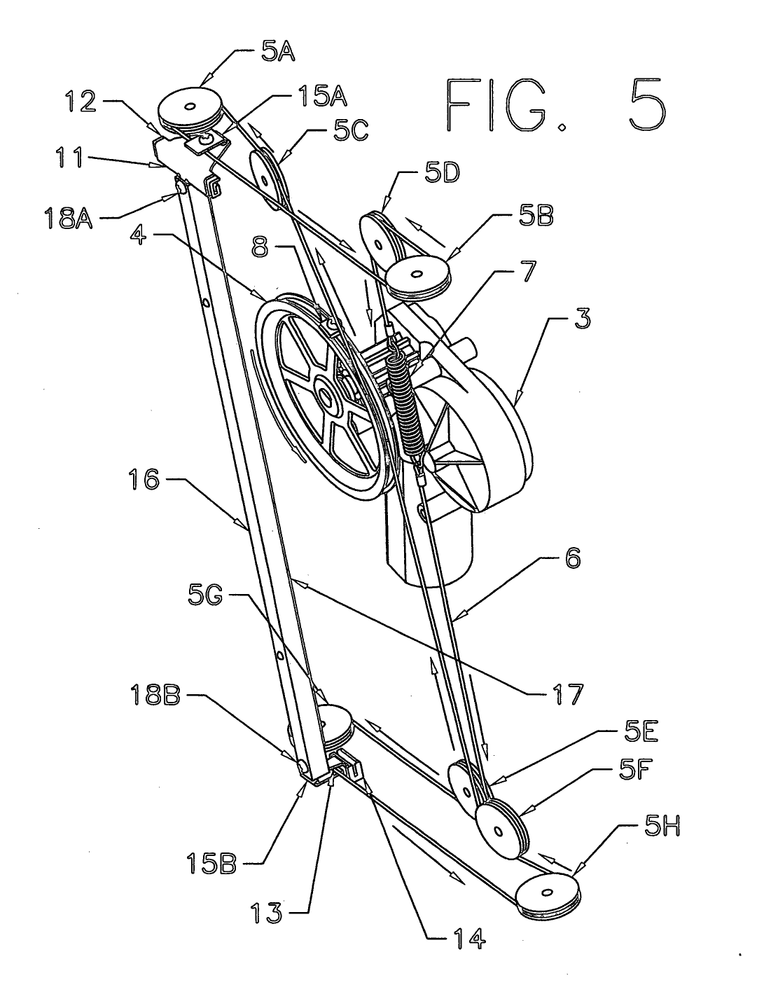

### FIG. 5

FIG. 5 shows all moving components with arrows indicating the motion as drive gearmotor 3 starts its rotation from parked position. Drive cable 6 starts at tensioning spring 7 and passes around idler pulleys 5F and 5H, then passes beneath lower wiper guide 13 and is secured by guide cable clamp 15B. It then passes around idler pulleys 5G and 5E and is then wrapped around drive pulley 4, where it is secured against slippage by drive pulley cable clamp 8. It then passes around idler pulleys 5C and 5A and then over upper wiper guide 11 where it is secured by guide cable clamp 15A and then passes over idler pulleys 5B and 5D and is then secured to the other end of tensioning spring 7. Following the arrows starting at drive pulley 4, as the drive gearmotor 3 rotates counterclockwise the cable rises to idler pulley 5C, then travels left to idler pulley 5A, then travels right to idler pulley 5B carrying upper wiper guide 11 with it, then travels around idler pulley 5B and left to idler pulley 5D and then down to idler pulley 5E, then left to idler pulley 5G, then right to idler pulley 5H carrying lower wiper guide 13 with it. It then goes around idler pulley 5H, travels left to idler pulley 5F and returns to drive pulley 4. The orientation of drive pulley cable clamp 8 is such that the drive gearmotor 3 can rotate through its travel (which will be less than 180 degrees) without interfering with the returning drive cable 6.

### Operation

This invention would typically be mounted in the same place as a normal mirror on a truck or bus. The invention would utilize pre-existing technology washer hose, pump and nozzle to provide a washing function. The invention can also be provided with remote angle adjusting means that also is pre-existing technology. The invention would be started by the driver pushing a button which would activate the washer motor and the wiper at the same time; the washer would would activate the washer motor and the wiper at the same time; the washer would continue for as long as the button is pressed and the wiper would have an electronic timer to continue for a predetermined time after the washer stops, and would then return to its park position. It could also be provided with a switch and a delay timer, so that it would wipe without washing at adjustable intervals exactly as the interval wipers on a modern automobile are operated. Again, this is existing technology and so is not included as part of this invention.

### Additional Embodiments

Another embodiment would be to power the wiper by an air motor instead of electric for use on heavy duty trucks, since many times air powered accessories are preferred on heavy duty trucks because of lower cost and/or greater reliability due to the corrosion that frequently occurs to electrical connections in the harsh environment in which trucks operate. As air operated wiper motors are readily available and oscillate exactly as do electric ones, this is a simple substitution. This inventor believes that electric motors are preferable, as they offer interval and time to shutdown features unavailable in air motors. Alternatively, the wiper could be powered by a linear oscillating air cylinder or electric linear motor (i.e. one that reverses automatically as it reaches its limit) thus eliminating the need for the drive pulley; however such cylinders and linear motors are not as commonly available as air or electric motors. In the future, however, they may become widely available and thus could be incorporated into this invention.

A further embodiment would be for smaller trucks and passenger automobiles. This would have the motor and drive pulley located inside the door panel and additional pulleys to guide the cable to the mirror. This embodiment would allow the wiper to work on a mirror that is longer than it is high, such as would be typical on an automobile. It would also allow this invention to be incorporated into a mirror assembly featuring both angle and tilt adjustment behind the mirror, as is common on more expensive automobiles. There are many ways to arrange the pulleys to accomplish this while adhering to the principles of this invention.

Another embodiment would utilize round guide rods instead of the thin blade guides shown in the drawings; this inventor built a prototype utilizing round guides as they were easier to fabricate with the machinery available. While consistent with the principles of this invention, this inventor believes that they are more obtrusive and more vulnerable to ice than the design shown in the drawings.

A third embodiment would be to have the wiper arm horizontal and vertically traversing the face of the mirror; but while that is not inconsistent with the principles of this invention this inventor does not favor this approach for reasons stated earlier.

I claim:

1. A rearview mirror wiping device for a vehicle comprising a supporting frame, a rectangular mirror, a top track, a bottom track, a wiper arm with guides on each end travelling on said tracks, a squeegee wiper blade attached to said wiper arm, a crossed wire rope loop to move said wiper arm and squeegee blade across said mirror, clamps to secure said wire rope to said wiper arm, idler pulleys to guide said wire rope through its desired path, and means to move said wire rope loop across said mirror face.

2. A motor with an oscillating rotary output and a drive sheave with the diameter calculated to move said wiper arm of claim 1 completely across said mirror face when rotated through the arc of travel of said motor whereby said wire rope loop of claim 1 is wrapped around said drive sheave and secured by a clamp to provide means of motion for said wire rope loop of claim 1.

3. Alternatively, a self reversing linear actuator to provide means of motion for wire rope loop of claim 1 whereby said wire rope is clamped to output means of said linear actuator.

4. The upper guide of claim 1 wherein said guide is an inverted “L” bracket to minimize the potential for obstruction.

5. The lower guide of claim 1 wherein said guide is a vertical blade located underneath said frame for protection from obstruction.

6. Alternatively, an upper guide rod consisting of a round bar with said upper guide of claim 1 incorporating a bushing to slide over said bar.

7. Alternatively, a lower guide rod consisting of a round bar with said lower guide of claim 1 incorporating a bushing to slide over said bar.

8. A tension spring in said crossed cable loop of claim 1 to eliminate slack in said cable.

9. A cover to provide protection from ice and debris for all moving items and to provide aesthetic appeal and improve aerodynamics.
